(19) United States
(12) Patent Application Publication
(10) Pub. No.: US 2019/0014070 A1
(43) Pub. Date: Jan. 10, 2019

(54) PERSONAL AUTOMATED TASK ASSISTANT

(71) Applicant: Findo, Inc., Menlo Park, CA (US)

(72) Inventors: Aleksandr MERTVETSOV, Moscow (RU); Alexander MAKUSHEV, Balashikha (RU); Victor KUZNETSOV, Sunnyvale, CA (US); Sergei RYKOV, Moscow (RU); Victor BOCHAROV, Saint Petersburg (RU); David YAN, Portola Valley, CA (US); Marina CHILINGARYAN, Berkeley, CA (US)

(21) Appl. No.: 16/030,558

(22) Filed: Jul. 9, 2018

Related U.S. Application Data
(60) Provisional application No. 62/552,625, filed on Aug. 31, 2017.
(60) Provisional application No. 62/530,798, filed on Jul. 10, 2017.

(51) Int. Cl. H04L 12/58; G06F 17/27

(52) U.S. Cl. CPC H04L 51/24; G06F 17/271; G06N 5/02; H04L 51/22; H04L 51/046

(57) ABSTRACT

A task assistant executed by a processing device receives a copy of a first correspondence sent by a first user in a first communication thread, wherein the first correspondence is addressed to a second user and the copy is sent to an automated task assistant. The task assistant determines that the first correspondence includes a request and a due date and monitors additional correspondence in the first communication thread to determine whether the request has been satisfied by the due date. Responsive to determining that the request has not been satisfied, the task assistant provides a notification with a reminder of the request to a client device associated with the second user in advance of the due date.

### RELATED APPLICATIONS

This application claims the benefit of U.S. Provisional Application No. 62/530,798, filed on Jul. 10, 2017, and of U.S. Provisional Application No. 62/552,625, filed on Aug. 31, 2017, the entire contents of each of which are hereby incorporated by reference herein.

### TECHNICAL FIELD

This disclosure generally relates to natural language processing (NLP), and more specifically to processing user correspondence using NLP to assist users with keeping track of requests that are incorporated into the user correspondence.

### BACKGROUND

Information overload is fast becoming one of the biggest problems affecting people's lives. One of the main sources of this overload is daily correspondence from a multitude of communication channels including email messages, text messages, voice messages, etc. Much of this correspondence includes requests that need to be fulfilled. For example, a person may be requested to review a report, call a client, confirm a payment, prepare a document, schedule a meeting, participate in closing a deal, provide an estimate for completing a project, and so on. As a result, a person may need to sort through the correspondence that incorporates those requests, understand the meaning of the requests and make sure that none of the requests are overlooked. In addition, a person may need to delegate some of these requests to others and make sure that the delegated requests are completed on time. Handling of incoming and outgoing requests has become very time consuming and has negatively affected individual and enterprise productivity.

### BRIEF DESCRIPTION OF THE DRAWINGS

The present disclosure is illustrated by way of example, and not by way of limitation, in the figures of the accompanying drawings.

FIG. 1 is a system providing assistance with correspondence of users, in accordance with some implementations.

FIG. 2 is a flow diagram of one implementation of a method for monitoring incoming correspondence, and sending alerts to users if the correspondence contains highly ranked requests.

FIG. 3 is a flow diagram of one implementation of a method for using a messaging interface to initiate interaction with a task assistant.

FIG. 4 is an example graphical user interface (GUI) provided by a task assistant, in accordance with some implementations of the disclosure.

FIG. 5 is a flow diagram of one implementation of a method for ranking contacts of a user.

FIG. 6 is a timing diagram illustrating email threads and task threads, according to an embodiment.

FIG. 7 is a flow diagram illustrating a method for processing new messages by the task assistant, according to an embodiment.

FIG. 8 is a block diagram illustrating logical processing operations of the task assistant, according to an embodiment.

FIG. 9 is an example computer system in which aspects of the present disclosure can be implemented.

### DETAILED DESCRIPTION

The present disclosure provides a task assistant (TA) designated to “remind” users of time-sensitive tasks received via various communication channels, which the users may have overlooked. The TA may be a cloud-based artificial intelligence (AI) system that creates daily reports and task lists based on features, or the data necessary for analysis, extracted from the corporate and private correspondence of the user. The TA allows tracking of the most important daily tasks that could have been overlooked, as well as keep track of tasks the user assigned to other co-workers for easier productivity management. The TA may determine that a particular correspondence is important (e.g., has been sent by an important contact of a user, has a close deadline, pertains to an important aspect of company business, etc.), and identify requests included in that correspondence (e.g. “finish that report by next Friday”) that have not yet been replied to or completed. The TA can automatically send an alert to a user via a messenger, a social network post, or another communication channel, where the user can see them sooner and with higher probability.

In one embodiment, the TA is embodied by a messaging interface, such that sending a message to or CC′ing a particular address associated with the TA can initiate tracking by the TA of one or more tasks described in the message. The message can include at least one of an email message, a text message, a chat message, a voice message, social media post or any other type of message. Using email as an exemplary embodiment, when a user receives an email message from a colleague, client, customer, friend, etc. that includes a request or a task to be completed, the user can forward the email message to an email address associated with the TA. Upon receipt of the email message, the TA can analyze the content of the email message to identify the request or task specified in the content. Once identified, the TA can create a new task thread or associate the email message with an existing task thread, as appropriate, and monitor additional correspondence related to the original email message to determine whether the request has been satisfied or the task completed. For example, the TA may analyze additional correspondence to identify a response from the user to the sender of the email message indicating that the request has been satisfied or the task completed. In one embodiment, the email message may also specify a due date by when the request or task is to be completed. Responsive to determining that the request has not been satisfied or the task completed, the TA may provide a notification with a reminder of the request or task to the user in advance of the due date.

Additional details of how the TA recognizes and prioritizes a task or request are provided below. In particular, according to some implementations, the TA can connect multiple data stores used by various communication channels (e.g., emails, files, contacts, notes, tasks, social networks, etc.) into a single platform, index data from the connected data stores and extract necessary metadata from the indexed data. The TA can also apply semantic analysis to the bodies of incoming messages to determine whether they include requests or tasks that need to be fulfilled.

In some implementations, the TA can rank the requests by their relative importance based on, for example, importance of a sender, sentiment analysis, included deadlines, previous actions of the user, etc. The importance of a sender can be deduced, for example, based on the frequency of communications between the user and the sender, the speed of the user's reaction to the sender's correspondence, the title of the sender, the name of the sender's company, etc. A variety of sender's contact details can be merged into one contact information item and can be considered when evaluating the sender's importance.

In some implementations, the TA can detect whether the request or task has been fulfilled, and send a notification to the user accordingly. The notifications can be sent via a messenger (e.g., a social network messenger, SMS messenger, etc.), a social network post, or any other communication channel. In addition, the TA can automatically add the request or task to a task tracker or calendar, add a flagging indicator to the correspondence incorporating the request or task, or change the status of such a correspondence. In some implementations, the TA can automatically execute a request/task, or suggest a reply to a request. For example, the TA can determine what type of information is requested, search for this information in the connected data stores, and suggest a reply including the found information to the user.

In some implementations, the TA can monitor correspondence of the user to other users to identify requests or tasks assigned to the other users. The TA can then rank these outgoing requests/tasks based on the importance of contacts associated with tasks/requests, completion deadlines, sentiment analysis, previous actions of the user, etc. The TA can detect whether the request or task has been completed, and send a notification to the requesting user or the user to whom the request/task was assigned via a messenger (e.g., a social network messenger, SMS messenger, etc.), a social network post, or any other communication channel.

Accordingly, aspects of the present disclosure assist users with addressing information overload by tracking requests/tasks incorporated into correspondence received by the users, prioritizing these requests/tasks, and providing appropriate and timely replies to the requests. Additionally, aspects of the present disclosure assist users with tracking requests/tasks delegated by the users to others, and ensuring that the delegated requests/tasks are completed on time. The TA is a service that does not necessarily require any app installation from the user on their own client, although they may have the choice to take advantage of an application and a web version as well. The messaging based interface described herein allows the user to continue their normal use of a corporate email address or business messenger to invoke the functionality of the TA. The TA, in turn, can use the same messaging interface to send task lists, reports, notifications and/or reminders periodically (e.g., every morning, every evening, etc.) or as needed.

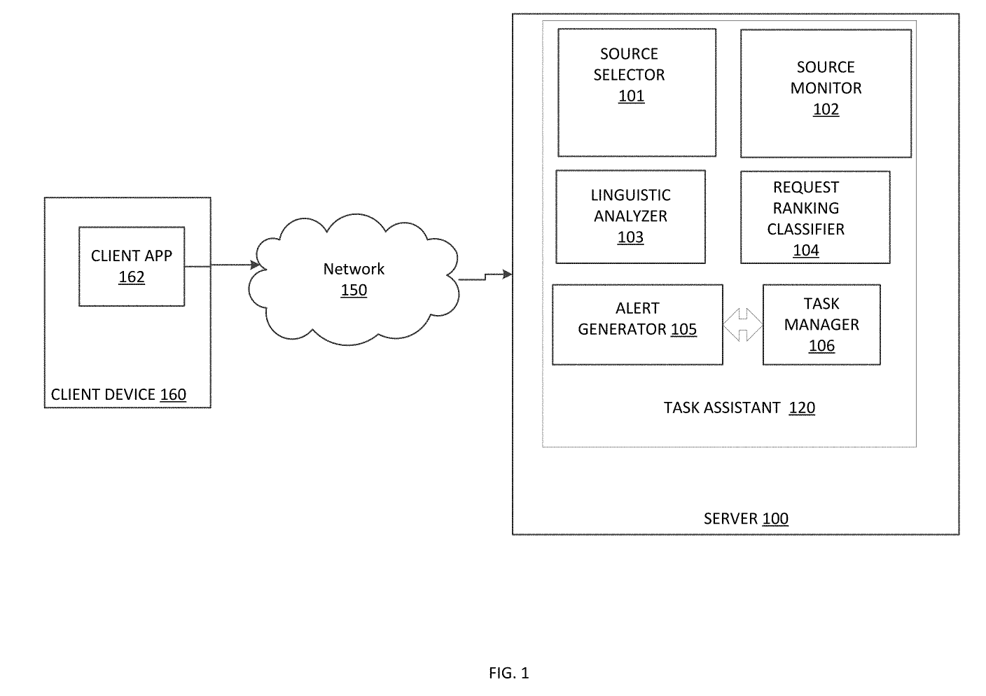

FIG. 1 illustrates an exemplary system architecture in which implementations of the present disclosure may operate. The system architecture may include a server 100 coupled to one or more client devices 160 via a network 150. The network 150 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. The system architecture may also include one or more data stores (not shown) that each can be a memory (e.g., random access memory), a cache, a drive (e.g., a hard drive), a flash drive, a database system, or another type of component or device capable of storing data. The data stores may also include multiple storage components (e.g., multiple drives or multiple databases) that may also span multiple computing devices (e.g., multiple server computers). The client devices 160 may each include computing devices such as personal computers (PCs), laptops, mobile phones, smart phones, tablet computers, netbook computers, network-connected televisions, etc. The server 100 may include one or more computing devices (e.g., a rackmount server, a server computer, etc.). The system architecture may also include third party systems such as one or more email systems, one or more messaging systems, one or more social network systems, one or more document management systems, one or more reporting systems, etc.

The data stores may be used by third party systems to store user correspondence and other documents. In certain cases, correspondence may have an unstructured data format or a structured data format. Correspondence having an unstructured data format can include, for example, email messages, text messages, files, attachments, faxes or images with text, voice messages, etc. Correspondence having a structured data format can include, for example, records from services such as Salesforces CRM, Jira Bug reporting, Asana Task Management, etc. While the present disclosure refers mostly to unstructured full-text data, with email messages as a main example, the techniques described herein can similarly apply to a wide variety of other unstructured and structured correspondence.

In one implementation, the server 100 includes a task assistant (TA) 120 which communicates with a client component 162 on each client device 160. TA 120 may be a server-based application performing the functionality described herein. The client component 162 can be, for example, a browser, a mobile application (app), a messenger bot, or any other module or program capable of communicating with TA 120 via the network 150.

In one implementation, TA 120 includes a source selector 101, a source monitor 102, a linguistic analyzer 103, a request ranking classifier 104, an alert generator 105 and a task manager 106. It should be noted that in other implementations TA 120 may include more or fewer components than those shown in FIG. 1. In one implementation, source selector 101 can communicate with the client component 162 to identify, based on user input, data stores used by email systems, messaging systems, social network systems, document management systems, reporting systems, etc. Source selector 101 may also determine a preferred alert channel. In one implementation, the alert channel is explicitly specified by the user via the client component 162. In another implementation, TA 120 determines the most appropriate channel automatically. For example, source selector 101 can monitor the usage of the various available channels and identify one of the channels that is used most frequently in a certain context. The context may include the content of the communication, the timing of the communication, the length of the communication, the recipient or sender of the communication, etc. Thus, based on previous activities for correspondence having the same or similar context, source selector 101 can identify an appropriate channel for future correspondence. In yet another implementation, TA 120 can select the alert channel automatically, but can later change it as a result of interactions with the user. For example, if TA 120 selects Skype messaging as a channel, but the user requests (e.g., via Skype messaging) an SMS channel, TA 120 can change the alert channel to SMS. In some implementations, the user can communicate with TA 120 as they would with a regular messaging system contact (e.g., via natural language texts such as “send my alerts via SMS”).

In one implementation, source monitor 102 monitors all incoming and outgoing correspondences, and passes new correspondences to linguistic analyzer 103. Linguistic analyzer 103 extracts word chains which can indicate requests or tasks. Such word chains can include phrases such as “could you please update,” “what time works,” “will it work for,” “I'd like to ask you to,” etc. In order to detect and extract applicable word chains, linguistic analyzer 103 can use predefined templates describing syntactic structures for variations of requests, and build syntactic and semantic interpretations based on the templates. In one embodiment, linguistic analyzer can use supervised machine learning to improve the recognition of word chains indicating requests or tasks over time. For example, linguistic analyzer 103 may receive a set of training data including correspondence having a known classification as either including a request/task or not. Linguistic analyzer 103 can implement a learning algorithm to analyze the training data and generate an inferred function to be applied to new correspondence. A human operator can also provide feedback on classifications performed by linguistic analyzer 103 over time to refine the inferred function.

Request ranking classifier 104 can assign a ranking to each request, defining which requests should be sent to the alert channel and in what order. A ranking can be based on, for example, word chain classification (content); the contact's importance; previous actions involving the given correspondence; the due date, etc. In some implementations, request ranking classifier 104 extracts the following information from the request/task: a contact who sent the relevant correspondence, the content of the request (what needs to be done), who has to do it, and by what date. Request ranking classifier 104 can then determine a ranking of the request based on the importance of the contact, the importance of the content of the request, the deadline for the request, and previous actions of the user. In one embodiment, the various extracted categories of information can be given a weighting value to define their importance relative to one another. In one embodiment, the categories have default weighting values (e.g., where the due date is weighted as most important). In other embodiments, a user can configure the weighting values according to their own preferences (e.g., to have the contact who sent the request be weighted as most important).

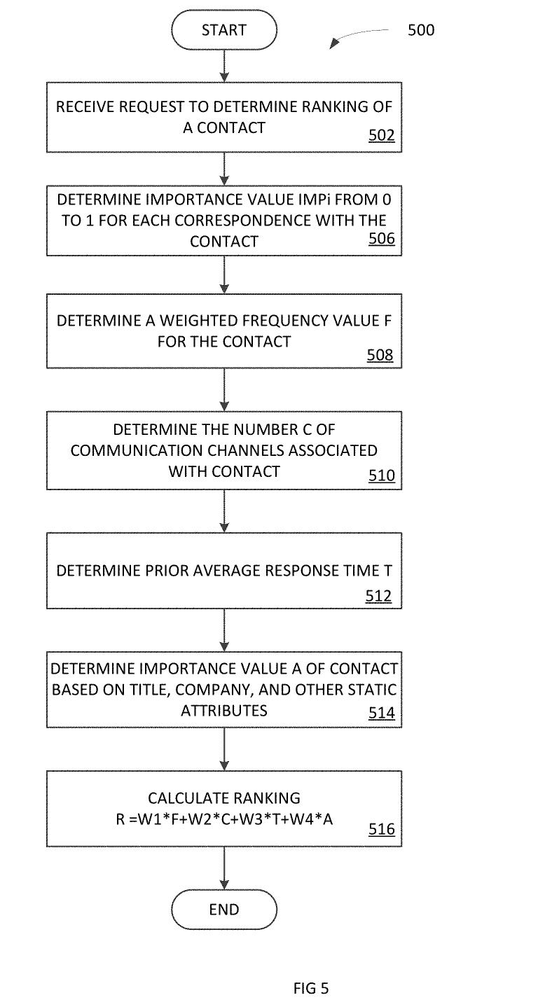

Contact importance can change dynamically, and, in one implementation, can be based on a set of parameters, which may include, for example: how many channels of the user the contact appears on; how frequently the user and the contact communicate; how quickly the user and the contact respond to each other's correspondences; the title of the contact, the company of the contact, celebrity status of the contact, etc. Importance of contacts can be compared based on rankings assigned to the contacts. One implementation of a method for ranking contacts of a user is discussed in greater detail below in conjunction with FIG. 5.

Content importance can be based on semantic analysis of the content that uses word chains as discussed above and weights some word chains higher than others. In one implementation, the Naïve Bayes text classification method may be used to detect words and expressions denoting importance. Alternatively, machine learning methods may be used in order to determine importance. In some implementations, supervised machine learning methods may rely on user feedback with respect to request rankings for expanding training sets. Such feedback may be provided by a user via alert channels by confirming importance of a request, or indicating a failure to detect a request, and its importance. In some implementations, an add-on or a plug-in for an existing communication application may be provided in order to simplify the process of providing negative or positive feedback. In one implementation, additional filtering may be performed in order to distinguish between non-request statements (e.g., statements in the form of politeness (e.g. “please find attached”), rhetorical questions, and other statements that may look similar to a request) and actual requests.

For example, a sentence “Huge problem, house on fire” can have an increased weight. In one implementation, a “sentiment” analysis can also be used to determine/adjust the importance of the content. For example, the tone of the email can be analyzed to determine whether it is strict, anxious, humorous, etc., and to adjust the importance accordingly.

Correspondence history or actions with a specific contact may affect request ranking. In one implementation, correspondence with the same contact is analyzed for unusual or contact specific patterns. For example, the correspondence may have been sent at midnight, whereas the contact usually communicates during the daytime. In another example, the contact may be frequently using “ASAP” in his or her correspondence, which should diminish the weight of such a term when determining the request ranking. In yet another example, the use of unusual recipients (e.g., in To:/CC: recipient's lists) in the contact's correspondence can affect the request ranking. In still another example, words denoting importance or urgency which were seldom used by the contact can be used to increase the request ranking. In one implementation, in order to enable said functionality, a contact specific inverted index may be implemented. In one implementation, a low-priority or zero-priority ranking can be assigned to the request if a previous action or actions indicate that the request has been completed (e.g. a requested file has been already sent).

If available, Due Date is extracted from the correspondence, and is used for ranking. In an implementation, if the due date is not explicitly defined, machine learning methods can be used to estimate the time needed for performing a certain task. In some implementations, supervised machine learning algorithms may rely on user feedback with respect to extracted due dates in order to expand the training set. Such feedback may be provided by the user via alert channels by confirming the extracted due dates, indicating a failure to extract the correct due date, or specifying a due data in order to train the system. In some implementations, an add-on or a plug-in for an existing communication application may be provided in order to simplify the negative or positive feedback process.

Due Date can be expressed as “absolute date” (e.g. May 1, 2016), or “relative” (e.g., next Thursday, the day after tomorrow, and so on). The absolute due date may be calculated based on the relative due date. In one implementation, information from previous interactions with the contact may be used. For example, if the user answered to the previous correspondence of the contact within an hour, a one hour deadline may be used for the subsequent responses.

In some implementations, request ranking classifier 104 can modify the assigned rankings in response to the user's request to change the priority of certain tasks, or to stop sending certain type of alerts.

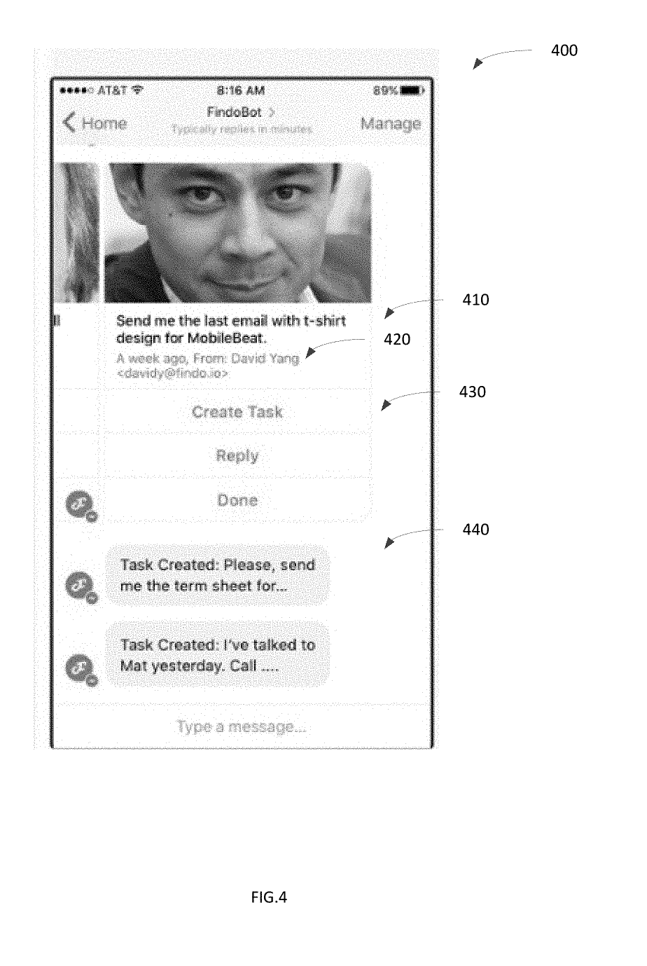

Alert generator 105 can use rankings of the requests to prioritize the requests, determine what requests should trigger alerts, generate these alerts and send the alerts to the user via the alert channel. The user may be provided with several options, which include but are not limited to (see FIG. 4 illustrating a screenshot of one implementation):
Disregard the alert (i.e., cancel it), or mark the request as completed. Sometimes TA 120 may not be able to automatically detect whether the request has been completed, and the request can to be “closed” manually.
Reply to/execute the request immediately.
Create a task which contains a due date and is monitored by task manager 106, alerting the user when appropriate. Task manager 106 can monitor the tasks, and periodically send notifications regarding outstanding tasks, or tasks approaching due dates.
Send feedback. TA 120 is adaptive, and can correct its future actions based on user feedback. Examples of feedback—“this person is not important”, or “this was not a request, but a joke.” The feedback can be used to automatically retrain the classifier, adjust word chain templates, or adjust contacts' profiles indicating contact's importance.

In one implementation, TA 120 attempts to understand the meaning of the request and assist in executing the request. For example, a contact may ask the user to share a copy of a particular presentation. Since the user has provided TA 120 with all his sources of information, and the sources are indexed, the request becomes a search request. If an appropriate document is found, the user has a choice to send it as is, or to find and send a correct document.

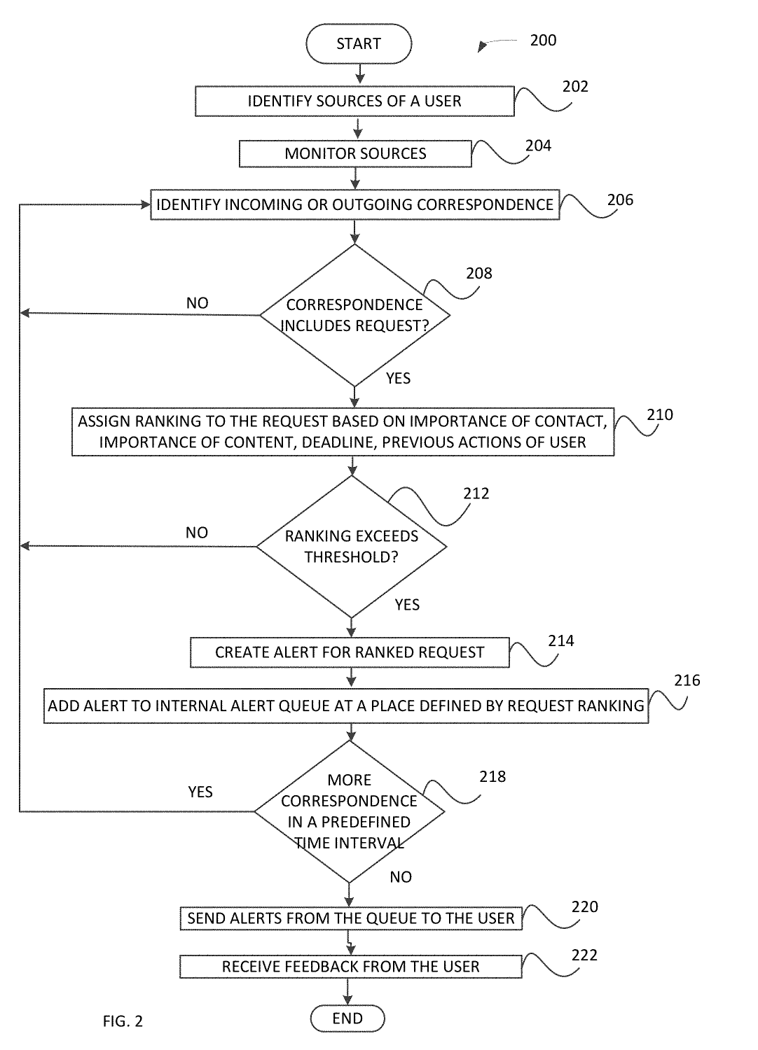

FIG. 2 is a flow diagram of one implementation of a method 200 for monitoring incoming correspondence, and sending alerts to users if the correspondence contains highly ranked requests.

Method 200 begins with TA 120 identifying sources of a user (block 202) as described above. For example, source selector 101 can communicate with the client component 162 to identify the various sources of correspondence for the user, including email systems, messaging systems, social network systems, document management systems, reporting systems, etc. In addition, source selector 101 may also determine a preferred alert channel for communication with the client device 160. TA 120 then monitors the sources of the user (block 204) and identifies correspondence received by the user from the user's contacts (i.e., incoming correspondence) or correspondence sent by the user to the user's contacts (i.e., outgoing correspondence) from different sources (block 206). In one implementation, source monitor 102 monitors all incoming and outgoing correspondences, and passes new correspondences to linguistic analyzer 103. In another implementation, source monitor 102 receives a message sent by the user at an email address, contact number, account identifier, etc. associated with TA 120, to which the user has specifically sent the message with an intent to invoke the functionality of TA 120.

One of the possible problems that can occur is when a user has multiple email addresses and will start communicating with TA 120 from multiple ones of these addresses. For the sake of efficiency and concrete results, TA 120 can merge several addresses into one. In one embodiment, the user is offered to connect all of their email accounts to a single TA account. In this case, all the email accounts can be treated as a single user. If the TA account “David” is connected to davidf@findo.com, and then if “Alena” tries to connect “davidf@findo.com” as a possible email account, the TA 120 will not allow it and will prompt that David has already previously connected the given email account. It will further suggest to confirm, if the person attempting to add the account is David or not and send a link to davidf@findo.com to log in to the TA 120.

Users of the TA 120 can be categorized as either “not active” or active.” The not active users include those who have been in some sort of correspondence with the TA 120 before, but never visited the TA's website and didn't sign a license agreement. These users can receive reminders from the TA 120 (or from the TA's active users), but they can't organize reminders themselves. They may unsubscribe from the reminders from the active TA users (but they can't completely unsubscribe from TA 120). The active users include those who have visited the TA's website and confirmed their email address (i.e. signed a licensed agreement). Active users can also be divided into two further sub-categories including those with connected email accounts and those without connected email accounts.

For the identified correspondence, TA 120 determines if a particular correspondence includes a request or task (block 208). If not, TA 120 proceeds to the next correspondence. If the correspondence does include a request or task, TA 120 assigns a ranking to the request or task based on the importance ranking of the contact (sender or recipient), the importance of the content, the deadline of the request, and previous actions of the user and/or the contact (block 211), as discussed herein. Next, TA 120 determines if the ranking of the request or task meets or exceeds a threshold (block 212). In one embodiment, an alert is not generated for all requests or tasks. For example, an alert may only be generated if the ranking of the request or task exceeds the threshold. Depending on the embodiment, the threshold may have a default value or may be configurable by the user. In one embodiment, for example, alerts may only be generated for the 100 highest ranked requests or tasks (i.e., the threshold is set at 100). In other embodiments, the threshold may be set at some other value. If the ranking does not meet or exceed the threshold, TA 120 proceeds to the next correspondence. If the ranking of the request does meet or exceed a threshold, TA 120 creates an alert for the ranked request (block 214), and places the alert in an alert queue at a position defined by the ranking of the alert (block 216). In one embodiment, all alerts are placed in the alert queue for processing. Alert generator 105 may retrieve an item from the alert queue in a sequential order. Thus, the position at which the item is placed in the alert queue can define the order in which a corresponding alert is generated. In one embodiment, the alert may be placed in an order according to the alert, ensuring that higher ranked alerts are processed sooner than lower ranked alerts. TA 120 determines whether there is more correspondence within a predefined time interval (block 218). If so, TA 120 then proceeds to the next correspondence, and blocks 206 through 216 are repeated for the next correspondence until all user correspondence is processed. Depending on the embodiment, the time interval may be set at different values, including for example, 30 minutes. The predefined time interval prevents the sending of numerous alerts if there are multiple correspondences that are sent or received in a short time period. By waiting until the predefined timer interval has passed, TA 120 can limit notifications to one alert. If there is no more correspondence within the time interval, TA 120 sends (block 220) alerts from the queue to the user (e.g., as a text message, an email, etc.). The alerts may be sent to the user based on their position in the queue, as discussed in more detail above. TA 120 may further receive feedback from the user in response to the alert (block 222). Such feedback may be provided by a user via alert channels by confirming importance of a request, or indicating a failure to detect a request, and its importance.

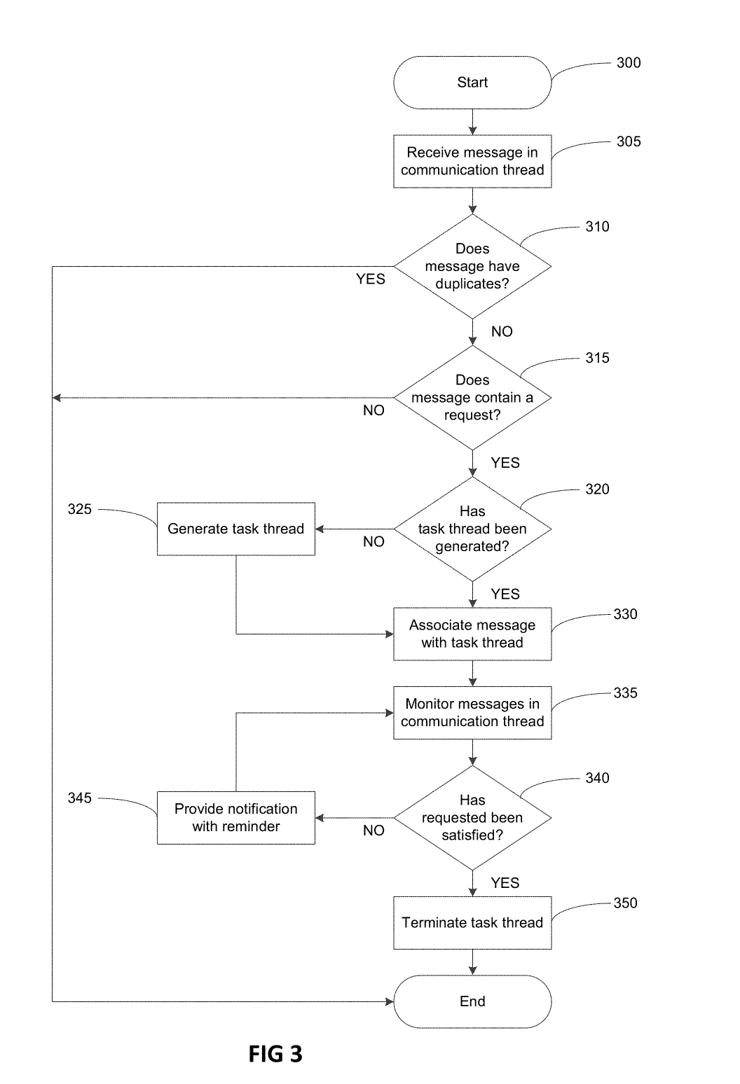

FIG. 3 is a flow diagram of one implementation of a method 300 for using a messaging interface to initiate interaction with task assistant 120.

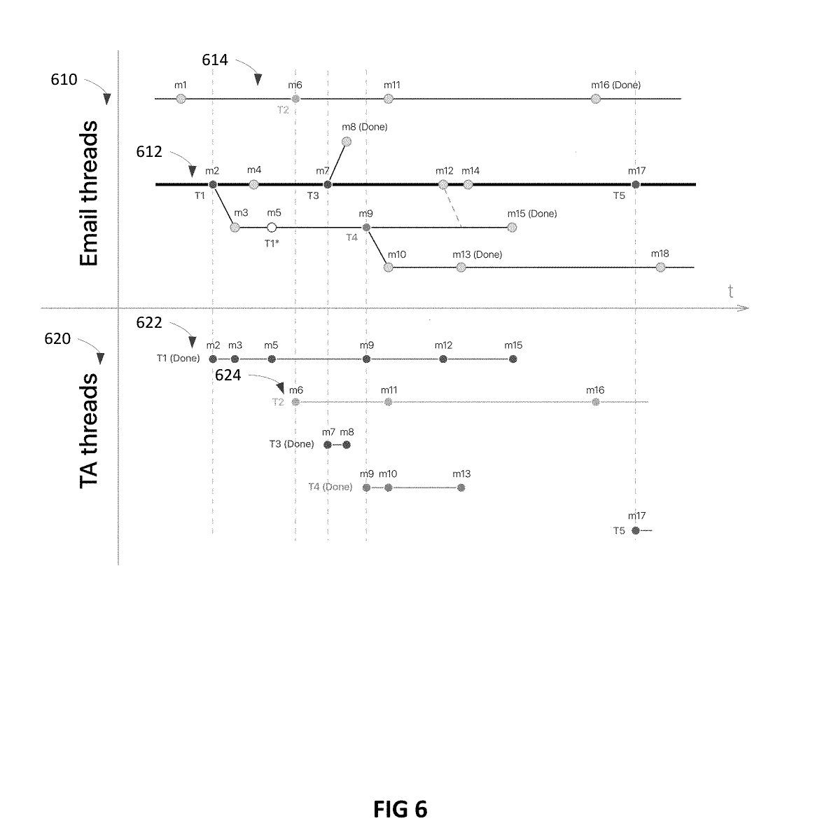

Method 300 begins at block 305, where TA 120 receives a copy of a first correspondence sent by a first user in a first communication thread. In one embodiment, the first correspondence is addressed to a second user and the copy is sent to TA 120. In on embodiment, the second user (i.e., the user of TA 120) may forward, “CC,” or otherwise send the first correspondence to TA 120. In one embodiment, first correspondence (e.g., an email message, a text message, a chat message, a voice message) may be part of a lengthy communication thread. The communication thread may include a series of messages (i.e., an original messages and any number of replies) that includes the first correspondence. The other messages in the communication thread may have been sent either before or after the first correspondence. Thus, the first correspondence sent to TA 120 may be a message that already was part of a longer email thread (see FIG. 6 for an example). It is possible that, if a new task is assigned in the middle of the communication thread, a new task thread with a corresponding task can be created by TA 120. In one embodiment, each task thread is associated with a single task, and for the sake of simplicity of realization, the TA 120 may not create a new task from an existing communication thread. However, in other embodiments, there can be reassignment of tasks and task fields, including the corresponding scopes, as described in more detail below.

At block 310, TA 120 determines whether a duplicate of the first correspondence is present in either the first communication thread or any other communication threads being monitored by TA 120, such as a second communication thread. Given the possibility that the user may send the same correspondence to TA 120 multiple times or that multiple users may send the same correspondence to TA 120, TA 120 can check for duplicates. In addition, when part of a longer communication thread, earlier messages may be repeated in or attached to later messages in the thread. In order to prevent the creation of multiple task threads for the same request or task, TA 120 can check for duplicates. To determine whether a duplicate of the message is present, TA 120 can compare certain characteristics or criteria of the first correspondence to that of other correspondence stored in an associated data store. For example, TA 120 can compare the sender, recipient, timestamp, length and/or contents of the first correspondence to others in the data store to determine if any duplicates are present.

If no duplicates of the correspondence are found, at block 315, TA 120 determines whether the correspondence includes a request or task to be completed. In one embodiment, linguistic analyzer 103 extracts word chains from the correspondence which can indicate requests or tasks, compares those chains to predefined templates describing syntactic structures for variations of requests, and builds syntactic and semantic interpretations based on the templates. In one embodiment, linguistic analyzer can use supervised machine learning to improve the recognition of word chains indicating requests or tasks over time. Linguistic analyzer 103 may further determine whether the correspondence includes a due date by which the request is to be satisfied or the task completed.

If the message does contain a request or a task to be completed, at block 320, TA 120 determines whether a task thread corresponding to the request has already been generated. In one embodiment, TA 120 maintains a separate task thread for each outstanding request or task being monitored. The task thread includes contextual information associated with the request/task, as well as all correspondence associated with the request/task. In one embodiment, the task described in the correspondence can be represented by an object in the task thread with the following fields:

### Task Model

ID tasks
Description—the description of the task from relevant messages
Status—completion status of a task (to do, done, dismissed)
Reason—reason of status changing (by user, by system, not my task, don't show task from author of this task)
Author (see Contact model below)—the person who assigns the task
AssignedTo[ ] (see Contact model below)—the list of persons who gets the task
SnoozedTill (Date)—snooze till this date, not empty value for snoozed tasks
Source—information about source, where task was detected
Messages[ ]—list of all relevant messages in the chronological order
Due (Date)—the deadline of completion for the task
Created (Date)—date of receipt of the message where the task was detected
LastUpdated (Date)—the date the task was last modified by user or by system
IsHot—using this flag the user or system can mark the task (affects the order of the task in the list, allows the system to filter the marked tasks)
Importance—a function to determine importance on a scale of 0-100 based on the following arguments: NLP sentiments of the email, NLP confidence, position of the original task message in the thread, sender's rank (individual vs robot in particular)

The task thread can further include contact information including information about a sender of the correspondence which included the request or task. A contact model representing that contact may include the following fields:

### Contact Model

ID contacts
DisplayName—display name of the contact
GivenName—given name of the contact
MiddleName—middle name of the contact
FamilyName—family name of the contact
Avatar—the avatar of a contact
Emails[ ]—list of emails of the contact
Phones[ ]—contact phone list
Team—information about organization, department associated with the contact
Messengers[ ]—list of instant message addresses for a contact
SocialProfiles[ ]—list of social profiles for a contact
Rank—contact importance

In one embodiment, any event associated with a task (such as creating a task, changing the task status with reason, assigning new message in the TA thread and etc.) are saved in task history. A task event can be represented by an object with the following fields:

### Task History Event Model

ID history events
TaskID—ID of a task for which this event was saved in history
EventType—type of history event
Payload—set of event parameters of the corresponding type
Date—date when the event has occurred

If at block 320, TA 120 determines that a task thread corresponding to the request has not already been generated, at block 325, TA 120 generates a new task thread. If a task thread has already been generated, at block 330, TA 120 associates the correspondence with the new or previously existing task thread. At block 335, TA 120 further monitors additional correspondence in the first communication thread to determine, at block 340, whether the request has been satisfied by the due date. In one embodiment, task manager 106 may analyze the additional correspondence in the thread to identify a response from the user to the sender of the email message indicating that the request has been satisfied or the task completed. In another embodiment, task manager 106 may receive data from other resources on or connected to server 100 from which it can determine whether the task has been completed. For example, if the task involved updating a document in a particular repository, task manager 106 may receive data from a storage controller tasked with managing the document repository, where said data can indicate if the particular document was updated and/or a status of an in-progress update. In this manner, the user need not specifically notify TA 120 that the task has been completed in order for TA 120 to make such a determination.

If the request has been satisfied, at block 350 TA 120 can terminate the corresponding task thread. If the request has not been satisfied, however, at block 345 TA 120 creates a reminder for the request and provides the reminder to the user tasked with completing the request. For example, TA 120 can automatically send a reminder to a user via a messenger, a social network post, or another communication channel, where the user can see them sooner and with higher probability. An example alert notification/reminder is illustrated and described below with respect to FIG. 4. In one embodiment, every reminder of a task created by a TA active user can be represented by an object with the following fields:

### Task Reminder Model

ID reminders
TaskID—ID of a task for which the reminder was created
RemindType—custom reminder type
RemindAt (Date)—date of sending a reminder of the specified type

The following scenarios describe possible implementations of the TA 120 described herein, according to various embodiments. Some of the scenarios include example email exchanges that illustrate portions of the functionality of the TA 120. In these example email exchanges, the address associated with the TA is “yva@yva.ai” and the example commercial product name of the TA 120 is “Yva.” This email address and name are merely examples and do not limit the functionality or applicability of the TA 120 in any way. There are a number of individuals described in the following scenarios including Alex (our primary user), and Boris (Alex's business partner).

Scenario 1: Alex—not an active user—emails TA (Email registration)

a) empty email—Alex doesn't have an email account registered with the TA. Alex sends an empty email to TA's email address:

FROM: Alex
TO: yva@yva.ai
CC:
“”

The empty email addressed to the TA's email address can be one indication that the sender of the email intends to register with the TA for future tracking services. The TA may determine whether the user was previously registered and if not, the TA responds:

FROM: yva@yva.ai
TO: Alex
CC:
Hi there!
Thank you for your email! I am Yva, and I am happy to become your
personal task assistant!
Please, confirm that you want to work with me by following this link.
It is very simple to work with me:
1. Just CC me (CC: yva@yva.ai) whenever you assign a task to someone,
and I will make sure the person doesn't forget about it and will let you
know if the task wasn't completed!
2. Ask your colleagues to CC me (CC: yva@yva.ai) when they ask you
about something important. I will make sure you don't forget about any
important task!
Yours sincerely,
Yva Task Assistant
yva@yva.ai

In one embodiment, the response email from the TA includes a hyperlink which, when selected, can direct the user to a web page where the user can complete registration. In another embodiment, the registration can be completed automatically simply by the initial sending of the email to the TA's email address.

b) email not empty, no quoting—Alex doesn't have an account with TA. Alex sends out an email with a certain content, but without any thread/quoting:

FROM: Alex
TO: yva@yva.ai
CC:
“Buy flowers in Friday”

In one embodiment, the TA responds to the email according to scenario 1 and thus creates Alex's account. After Alex's registration, TA sends another email to Alex according to scenario 4 (scenario with no quoting).

c) email not empty, with quoting—Alex doesn't have an account with TA. Alex sends TA an email with a thread/quoting. TA responds to Alex's email according to scenario 1 and thus creates Alex's account. After Alex's registration, TA sends him another email following scenario 4 (scenario with quoting).

Scenario 2: Alex (an active user) emails Boris (a non-user) and CC's TA. Alex has a TA account. Alex sends an email with a task to Boris.

FROM: Alex
TO: Boris
CC: yva@yva.ai
Boris, hi, please send me the presentation by Tuesday!

In one embodiment, the TA identifies the task from the text of Alex's email, as well as the corresponding deadline. The TA can create a new task object in its data store representing this task and use that task object to track progress and monitor completion of the requested task. The TA responds to Alex's email to notify Alex that it is tracking the progress of the requested task, as follows:

FROM: yva@yva.ai
TO: Alex
CC:
Hi, Alex!
I can see you asked Boris: “Please send the presentation.”
Due date: “by Tuesday”, i.e. 03.04.17
I will remind Boris about it 2 days before the due date.
If you want to change the reminder settings or view all your active tasks,
please follow this link.
Yours sincerely,
Yva
FROM: Alex
TO: Boris
CC: yva@yva.ai
Boris, hi, please send me the presentation by Tuesday!

In one embodiment, some period of time (e.g., two days) before the deadline, the TA can send Boris an email and CCs Alex by “replying all” to Alex's original email. In one embodiment, the TA only sends the reminder if the task has not already been completed (i.e., if Boris has not responded to Alex's email to confirm that the task was completed). The given task also appears in Alex's To-Do List:

FROM: yva@yva.ai
TO: Boris
CC: Alex
Hi, Boris!
I am Yva, Alex's personal task assistant. This is a friendly reminder that
Alex asked you: “Please send the presentation.”
Due date: “by Tuesday”, i.e. 03.04.17.
I can't find any information in Alex's email that would indicate the task
has been completed.
Please, reply to Alex regarding the following question and CC me in the
email
CC: yva@yva.ai,
If you have completed the task, please indicate that it's completed in the
email.
Always in touch,
Yva
P.S.: Boris, I am an electronic assistant - I am not a human. I am helping
Alex in managing his tasks. But I am more than happy to help you manage
your tasks for free, too! All you have to do is send me an email at
yva@yva.ai, and I will give you all the details on how to work with me.
FROM: Alex
TO: Boris
CC: yva@yva.ai
Boris, hi, please send me the presentation by Tuesday!

Scenario 3: Alex (not a user) emails Boris and CC's TA. Alex doesn't have a TA account. Alex sends an email with a task to Boris.

FROM: Alex
TO: Boris
CC: yva@yva.ai
Boris, hi, please send ME the presentation by Tuesday!

TA responds to Alex according to Scenario 1 and creates Alex's new TA account. After Alex's registration, TA sends an email to Alex according to scenario 2.

Scenario 4: Alex (active user) emails TA. Alex has a TA account. Alex sends an email according to one of the following examples.

a1) no content or a text with no more than 5 words, containing “ToDo”, “To Do”, “Task”, “Tasks” (no thread/quoting):

FROM: Alex
TO: yva@yva.ai
CC:
“Show me my tasks”

The TA interprets this message as a request by Alex to view all outstanding tasks. This may include tasks assigned to Alex and tasks assigned to others (e.g., Boris) by Alex. In on embodiment, the TA responds to Alex by sending the current daily report.

a2) a text that doesn't fall under description a1) (no thread/quoting)

FROM: Alex
TO: yva@yva.ai
CC:
Schedule a staff meeting

The TA may interpret the text of this email as a request by Alex to create a new task. In one embodiment, the TA processes the email to identify the task and the due date from the content. If the processing is successful, a new task is created with the mentioned parameters and a “hot” flag. If not, a new task is created with the due date set to “immediately.” Alex is considered the originator and the executor of the task. In one embodiment, the TA sends Alex an email as a reply (with the quoting of Alex's original letter):

FROM: yva@yva.ai
TO: Alex
CC:
Alex,
I flagged the task as “hot.”
Due Date: 25 July 2017
FROM: Alex
TO: yva@yva.ai
CC:
Schedule a staff meeting

b) empty content of the latest email in the thread, but not an empty thread (there was quoting—meaning content from a previous email in the thread)

FROM: Alex
TO: yva@yva.ai
CC:
From: Boris Chilingaryan <borisc@findo.com>
Date: Monday, July 24, 2017 at 09:03
To: David Yang <davidy@findo.com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

This type of email can indicate that Alex wants the TA to remind him about this task from Boris, and if there was no such previous email from Boris, then a new task can be created. In one embodiment, the TA tries to understand if there was a similar email from Boris in Alex's inbox before, and if yes, whether it was detected as a task. If there was a previous email from Boris and there was a detected task, TA can flag the task as “hot” (i.e., having a greater importance). If there was a previous email, but it wasn't detected as a task, the email is marked as a task and flagged as “hot.” If there was no such email from Boris, then TA flags the email from Alex as “hot.” In any case, the TA tries to understand the content of the task and the due date from Boris's email. If the deadline is identified in Boris's email, then it can be set as Due Date. If not, the Due Date is marked as “immediately” by default. The TA can then send Alex a reply email (with the quoting of his email to TA):

FROM: yva@yva.ai
TO: Alex
CC:
Alex,
I flagged the task as “hot.”
DueDate: 25 July 2017 (″...2 pm zoom meeting tomorrow...″)
FROM: Alex
TO: yva@yva.ai
CC:
From: Boris Chilingaryan <borisc@findo.com>
Date: Monday, July 24, 2017 at 09:03
To: David Yang <davidy@findo.com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

c1) case b), but with content in the last email of the thread which:

A. only includes a date
B. or just the date and a “remind” intent
C. or just a “remind” intent

FROM: Alex
TO: yva@yva.ai
CC:
remind me in 3 days
From: Boris Chilingaryan <borisc@findo.com>
Date: Monday, July 24, 2017 at 09:03
To: David Yang <davidy@findo.com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

This means the same as in case b), but Alex clearly wants to convey the date for the reminder. In one embodiment, the TA tries to understand if there was an email from Boris with a similar content in Alex's inbox, and if yes, whether it was detected as a task or not. As described above, if yes, TA deletes the task's flag from the same email (see below). If there was an email, but it wasn't detected, see below. If there was no such email from Boris, see below. In any case, TA flags a task in Alex's email as “hot.” TA tries to find the deadline in Alex's email to TA, and if she finds it, the date is set as the due date. If there are no dates in Alex's email, TA tries to find the date in Boris's email and sets it as the Due Date. In addition, the TA may create a task with the description extracted from Boris's email and reply to Alex's email (quoting Alex's email to TA):

FROM: yva@yva.ai
TO: Alex
CC:
Alex,
I flagged the task as “hot.”
DueDate: 28 July 2017 (″...remind me in 3 days...″)
FROM: Alex
TO: yva@yva.ai
CC:
remind me in 3 days
From: Boris Chilingaryan <borisc@findo.com>
Date: Monday, July 24, 2017 at 09:03
To: David Yang <davidy@findo.com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

c2) case c1), which doesn't match cases A., B., C.

FROM: Alex
TO: yva@yva.ai
CC:
remind me in 3 days so will be able to set up an account
From: Boris Chilingaryan <borisc@findo.com>
Date: Monday, July 24, 2017 at 09:03
To: David Yang <davidy@findo,com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

This means the same as the cases c1) and above, but Alex clearly wants to share more information. TA completes everything from c1) with the one difference when TA creates a task with the description extracted not from Boris's email, but from Alex's email for TA: “remind me in 3 days so will be able to set up an account.”

d) case c1) or c2) above, but Alex sends an email to TA again with a different content.

FROM: Alex
TO: yva@yva.ai
CC:
remind me in 5 days, i need to prepare a new presentation
FROM: Alex
TO: yva@yva.ai
CC:
remind me in 3 days
From: Boris Chilingaryan <borisc@findo.com>
Date: Monday, July 24, 2017 at 09:03
To: David Yang <davidy@findo.com>, Gary Fowler <garyf@findo.com>,
Jamie Lee <jamielee@findo.com>
Subject: Re: KPI meeting
David,
The code for the 2 pm zoom meeting tomorrow is 9499414477! Please
join.

This means the same as cases c1) or c2) above, but Alex clearly wants to convey some updated information about the given task and/or change the date. TA follows the steps of c1) or c2) considering Alex's new email to TA as a task (removing the flag from Alex's previous email to TA) and confirms a new Due Date in case it was mentioned.

Scenario 5: Boris emails Alex (a TA user) and CC's TA. Alex has an account with TA. Alex receives an email with a task:

FROM: Boris
TO: Alex
CC: yva@yva.ai
Alex, hi, please send the presentation by Tuesday.

In one embodiment, the TA replies to this by following the steps in scenario 4b. The given task appears in Alex's To-Do List and two days before the deadline, TA sends an email to Alex (reply all) and CC's Boris:

FROM: yva@yva.ai
TO: Alex
CC: Boris
Alex, hi!
This is a friendly reminder that Boris asked you to “send the presentation.”
Due date: “by Tuesday,” i.e. 03.04.17.
I can't find any information in your correspondence that would confirm
the completion of the task.
Please respond to Boris and CC me in the email CC: yva@yva.ai.
If you have completed the task, please note in the email that it is
completed.
Yours sincerely,
Yva
FROM: Boris
TO: Alex
CC: yva@yva.ai
Alex, hi, please send the presentation by Tuesday.

Scenario 6: Boris emails Alex (non-user) and doesn't CC TA. Alex has an account with TA. Alex receives an email with the following task:

FROM: Boris
TO: Alex
CC: -
Alex, hi, please send the presentation by Tuesday.

TA responds to this email in the traditional way: the content of the task and the due-date are extracted, the originator is Boris, the executor—Alex. If TA is successful, a new task is created with the following parameters. The given task then appears in Alex's To-Do list. If not, the task is not created.

FIG. 4 is an example graphical user interface (GUI) 400 provided by TA, in accordance with some implementations of the disclosure. In one embodiment, GUI 400 illustrates an identified correspondence which includes a request 410 (i.e., “Send me the last email with t-shirt design for MobileBeat”). In addition to a copy of the request 410 itself, GUI 400 further includes information 420 about the correspondence containing the request. In one embodiment, this information 420 includes a time when the request was received (i.e., “a week ago”) and an indication of the sender of the request (i.e., “David Yang <davidy@findo.io>”). In addition, GUI 400 includes a number of action buttons 430 which can receive user input to initiate a corresponding action with respect to the request. The action buttons 430 can include, for example, “Create Task,” “Reply,” and “Done.” A selection of the “Create Task” button may cause TA 120 to create a task corresponding to the request 410 and add the task to a calendar, task list, or other data store. A selection of the “Reply” button may cause TA 120 to generate a reply to the sender of the correspondence identified in information 420. A selection of the “Done” button may cause TA 120 to dismiss the task as being complete or unnecessary to be tracked further. In other embodiments, GUI 400 may include different or additional action buttons. Furthermore, GUI 400 may include a conversation 440 associated with the request 410. The conversation 440 may include, for example, additional communications between the user and the sender of the correspondence. In addition, the conversation 440 may include notes associated with the processing of the request 410 (e.g., “Task Created”).

FIG. 5 is a flow diagram illustrating a method 500 of determining ranking of a contact in accordance with some implementations of the present disclosure. At block 502, TA 120 receives a request to determine the ranking of a contact. At block 506, TA 120 determines an importance value IMPi of each correspondence or content associated with the contact. In one embodiment, the importance can be determined on the basis of how quickly a user replies to the emails or other requests of the request sender. In another embodiment, if the importance of the sender can be determined on the basis of some other information from internal or external sources, such as a website, that indicate whether the sender is a well-known person, or on the basis of a title in the senders signature (e.g., CEO, CIO etc.), or other content of the email which helps to understand that this sender has an important corporate or social position.

In one implementation, the importance value may be expressed as a binary value 0 or 1, where a correspondence of zero importance can be discarded from the consideration. In another implementation, the importance value may vary from 0 to 1.

At block 508, TA 120 determines the weighted frequency F of the correspondence exchanged with a certain contact for a given period of time as a sum of all importance values. The period of time may be a predetermined period of time consistent across all contacts of a given user. At block 510, TA 120 determines the number of communication channels C. The channels may include, for example, multiple email channels, messaging channels, content sharing channels, phone communication channels, etc. In one embodiment, the number of communication channels includes an indication of how many different channels have been used for correspondence between the user and a particular one of the user's contacts. In one embodiment, when the user has communicated with a contact using a higher number of different channels (e.g., email, phone, messaging, social media), this may be an indication that the contact is of greater importance than a contact with which the user has communicated using only a single channel (e.g., email).

At block 512, TA 120 determines an average response time T of the user to the contact's requests and of the contact to the user's requests based on the history of communications between the user and the contact. In one implementation, the outgoing correspondence response time may be weighted higher, as it reflects the urgency of the responses.

At block 514, TA 120 determines a static contact value based on certain contact attributes. The contact attributes may include, for example, the title of the contact, the company name, the celebrity status, etc. In one implementation, TA 120 may maintain profiles for the user's contacts, and the above static contact attributes may be stored in the contact's profile.

Finally, at block 516, TA 120 calculates the ranking R of a contact. In one implementation, the ranking is calculated as a weighted sum of values determined in previous blocks. Weights W1, W2, W3, W4 can be predefined based on experimentations, or, in another implementation, derived from the user's feedback using machine learning methods. The ranking may be updated regularly in order to account for new correspondences and reduce the importance of old correspondences. In one implementation, contacts from multiple sources—address book, cloud depositories, emails, etc.—can be aggregated using the following methods:
Parsing of the full name to extract the name and surname.
Use of phonetic and Levensthein distance based algorithms to merge names with errors in spelling.
Parsing of the phone numbers (the country code, city etc.) for proper phone comparisons.
Comparison of email addresses.
Assessment of name validity based on incoming and outgoing correspondence statistics.
Obtaining additional data about the contact from social networks.

FIG. 6 is a timing diagram illustrating email threads 610 and task threads 620, according to an embodiment. In one embodiment, a first email thread 612 (i.e., a communication thread) begins with a message m2 that includes a first task T1. Upon message m2 being sent to TA 120, and TA 120 verifying that a corresponding task thread 620 does not already exist, TA 120 can generate a corresponding task thread 622. The task thread 622 includes reference to the original message m2, as well as other messages that pertain to task T1 (i.e., m3, m5, m9, m12, m15) whether in original email thread 612 or in one of various threads branching off of email thread 612. TA 120 may terminate task thread 622 upon determining that the corresponding task T1 was completed based on the contents of message m15.

In one embodiment, email thread 612, and the branching threads may later include new tasks (i.e., T3, T4, T5). Upon being detected, TA 120 can generate corresponding task threads for each identified task. In one embodiment, the first correspondence sent to TA 120 may be a message that already was part of a longer email thread 614. For example, thread 614 may begin with message m1, but a task T2 is not identified until a later message m6. In response, TA 120 may generate a corresponding task thread 624 which includes reference to message m6, as well as other messages that pertain to task T21 (i.e., m11, m16).

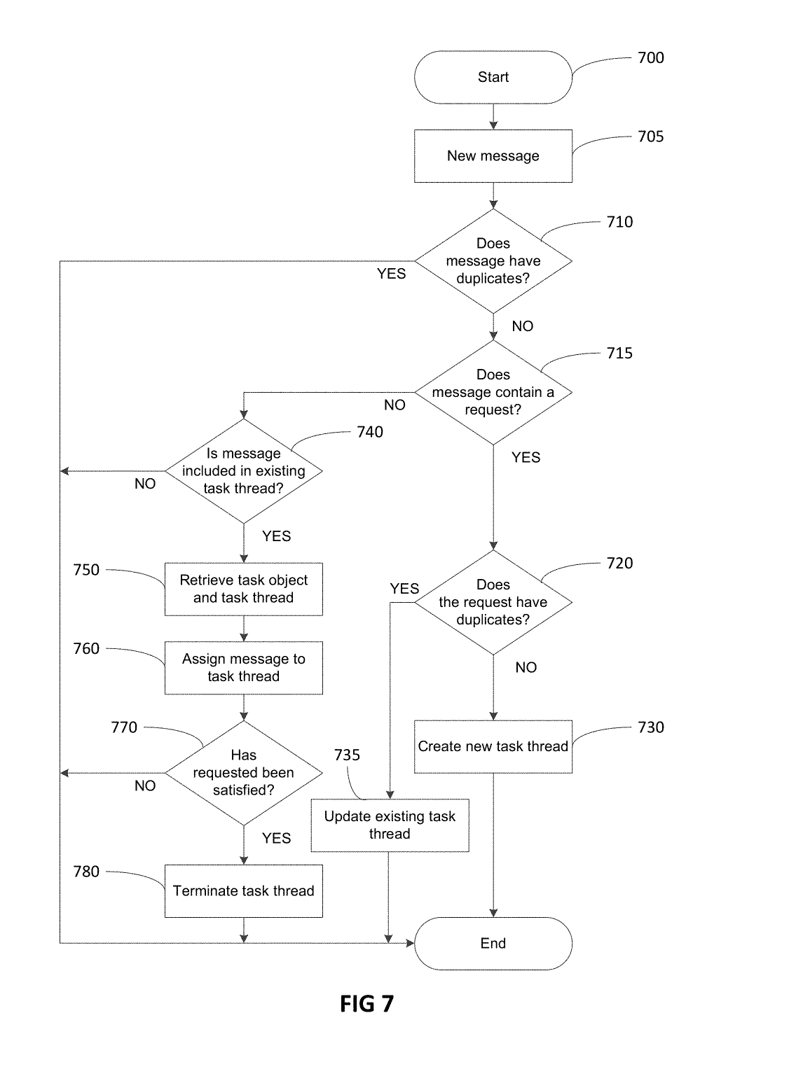

FIG. 7 is a flow diagram illustrating a method 700 for processing new messages by the task assistant, according to an embodiment.

Method 700 begins at block 705, where TA 120 receives a copy of a first correspondence sent by a first user in a first communication thread. In one embodiment, the first correspondence is addressed to a second user and the copy is sent to TA 120. In on embodiment, the second user (i.e., the user of TA 120) may forward, “CC,” or otherwise send the first correspondence to TA 120. At block 710, TA 120 determines whether a duplicate of the first correspondence is present in either the first communication thread or any other communication threads being monitored by TA 120, such as a second communication thread. If no duplicates of the correspondence are found, at block 715, TA 120 determines whether the correspondence includes a request or task to be completed. In one embodiment, linguistic analyzer 103 extracts word chains from the correspondence which can indicate requests or tasks, compares those chains to predefined templates describing syntactic structures for variations of requests, and builds syntactic and semantic interpretations based on the templates. In one embodiment, linguistic analyzer can use supervised machine learning to improve the recognition of word chains indicating requests or tasks over time.

If the message does contain a request or a task to be completed, at block 720, TA 120 determines whether the request has any duplicates. If there are no duplicates, at block 730, TA 120 creates a new task thread, as described above. If there is a duplicate, at block 735, TA 120 identifies the existing task thread and updates it with the new data from the message that can change the existing values of the given task (e.g., Status, Due Date, Description, Importance, etc.).

If the message does not contain a request, at block 740, TA 120 determines whether the message corresponds to an existing task thread. In one embodiment, TA 120 maintains a separate task thread for each outstanding request or task being monitored. The task thread includes contextual information associated with the request/task, as well as all correspondence associated with the request/task.

If message corresponds to an existing task thread, at block 750, TA 120 retrieves the task thread and corresponding task object, and at block 760 associates the new message with the task thread. At block 770, TA 120 further monitors additional correspondence in the first communication thread to determine whether the request has been satisfied. In one embodiment, task manager 106 may analyze the additional correspondence in the thread to identify a response from the user to the sender of the email message indicating that the request has been satisfied or the task completed. In another embodiment, task manager 106 may receive data from other resources on or connected to server 100 from which it can determine whether the task has been completed. If the request has been satisfied, at block 780 TA 120 can terminate the corresponding task thread.

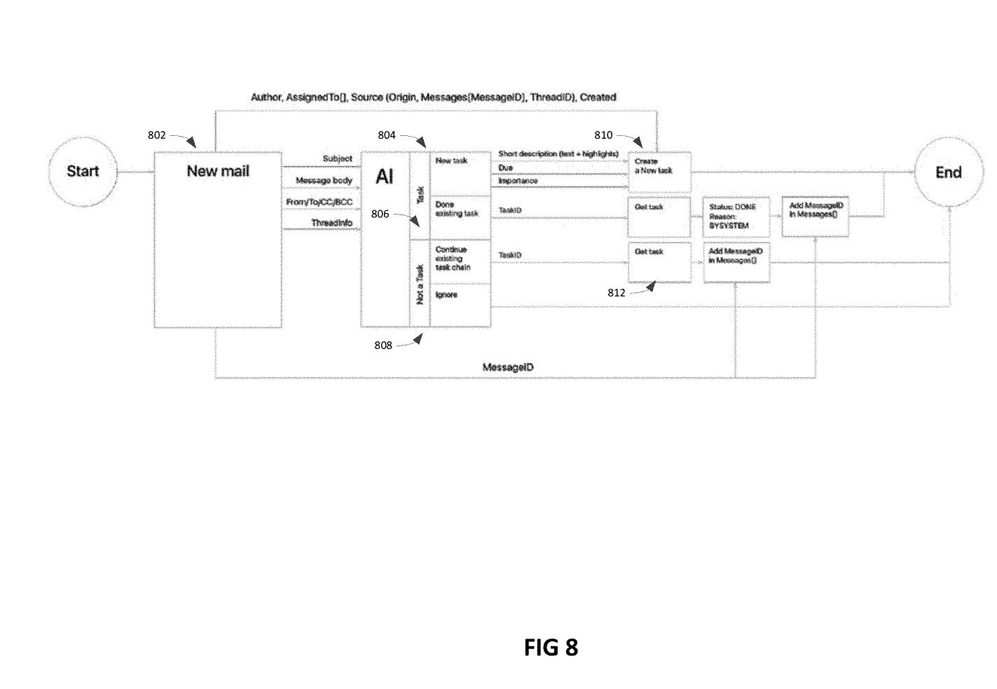

FIG. 8 is a block diagram illustrating logical processing operations of the task assistant, according to an embodiment. Block 802 represents a new correspondence (e.g., an email or other message) that is received by TA 120. TA 120 receives a copy of the new correspondence sent by a user. In on embodiment, the user may forward, “CC,” or otherwise send the correspondence to TA 120. TA 120 may receive various context information about the new mail at block 802 including a subject, a message body, From/To/CC/BCC information, and other information about the communication thread in which the message is contained. TA 120 makes a determination of whether the new correspondence includes a task. Block 804 represents a determination that there is a new task not previously recognized by TA 120. Block 806 represents a determination that there is a previously recognized task in the correspondence. Blocks 808 represent a determination that the correspondence does not include a task. According to the task determination, TA 120 may create a new task thread at block 810 as needed based on a description of the task, a due date, and a level of importance. Otherwise, TA 120 may identify an existing task thread using a TaskID at blocks 812. As described above, TA 120 may continue monitoring the various active task threads, adding new messages and information as it is determined, and may terminate the task threads upon completion of the associated task.

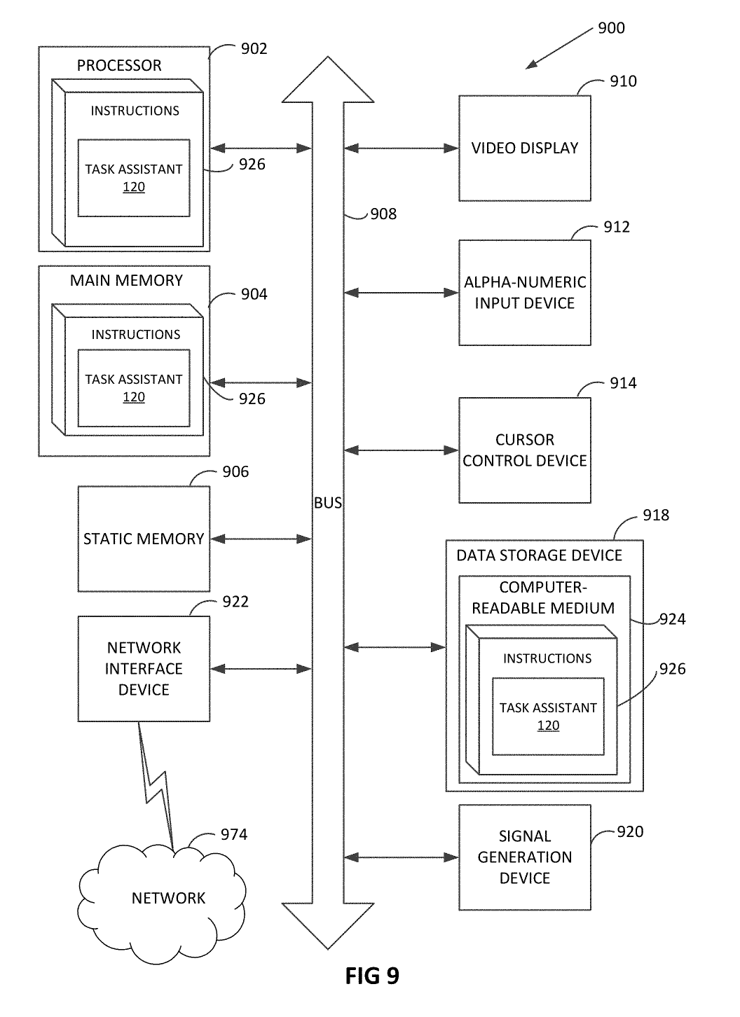

FIG. 9 depicts a block diagram of a computer system operating in accordance with one or more aspects of the present disclosure. In certain implementations, computer system 900 may be connected (e.g., via a network, such as a Local Area Network (LAN), an intranet, an extranet, or the Internet) to other computer systems. Computer system 900 may operate in the capacity of a server or a client computer in a client-server environment, or as a peer computer in a peer-to-peer or distributed network environment. Computer system 900 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 900 may include a processing device 902, a volatile memory 904 (e.g., random access memory (RAM)), a non-volatile memory 906 (e.g., read-only memory (ROM) or electrically-erasable programmable ROM (EEPROM)), and a data storage device 916, which may communicate with each other via a bus 908.

Processing device 902 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 900 may further include a network interface device 922. Computer system 900 also may include a video display unit 910 (e.g., an LCD), an alphanumeric input device 912 (e.g., a keyboard), a cursor control device 914 (e.g., a mouse), and a signal generation device 920.

Data storage device 916 may include a non-transitory computer-readable storage medium 924 on which may store instructions 926 encoding any one or more of the methods or functions described herein, including instructions encoding task assistant 120 of FIG. 1 and for implementing method 200, method 300, method 500 or method 700.

Instructions 926 may also reside, completely or partially, within volatile memory 904 and/or within processing device 902 during execution thereof by computer system 900, hence, volatile memory 904 and processing device 902 may also constitute machine-readable storage media.

While computer-readable storage medium 924 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “detecting,” “determining,” “initiating,” “creating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform the method and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving a copy of a first correspondence sent by a first user in a first communication thread, wherein the first correspondence is addressed to a second user and the copy is sent to an automated task assistant;
determining, by a processing device associated with the automated task assistant, that the first correspondence includes a request and a due date;
monitoring additional correspondence in the first communication thread to determine whether the request has been satisfied by the due date; and
responsive to determining that the request has not been satisfied, providing a notification with a reminder of the request to a client device associated with the second user in advance of the due date.

2. The method of claim 1, further comprising:
determining that a duplicate of the first correspondence is not present in the first communication thread or a second communication thread.

3. The method of claim 1, further comprising:
determining that a task thread corresponding to the request has already been generated by the automated task assistant; and
associating the first correspondence with the task thread.

4. The method of claim 1, further comprising:
generating a task thread corresponding to the request; and
responsive to determining that the request not been satisfied, terminating the task thread.

5. The method of claim 1, wherein receiving a copy of the first correspondence comprises receiving at least one of an email message, a text message, a chat message, or a voice message.

6. The method of claim 1, wherein determining that the first correspondence includes a request comprises:
extracting a word chain from the first correspondence; and
identifying a syntactic structure of the request in the word chain that matches a predefined request template.

7. The method of claim 1, further comprising:
determining a ranking associated with the request based on one or more characteristics of the request and of the first correspondence, wherein the one or more characteristics comprises at least one of an importance of a contact from whom the correspondence was received, sentiment analysis, the due date referenced in the first correspondence, previous actions of the user, frequency of prior correspondence with the contact, response time to prior requests from the contact, a title of the contact, or a name of the contact's company, and wherein determining the ranking comprises:
identifying a contact from whom the first correspondence was received; and
calculating a weighted sum of an importance of past correspondence with the contact, a number of communication channels associated with the contact, an average response time to prior requests from the contact and a static attribute importance value of the contact.

8. A system comprising:
a memory; and
a processing device, operatively coupled to the memory, the processing device to:
receive a copy of a first correspondence sent by a first user in a first communication thread, wherein the first correspondence is addressed to a second user and the copy is sent to an automated task assistant;
determine that the first correspondence includes a request and a due date;
monitor additional correspondence in the first communication thread to determine whether the request has been satisfied by the due date; and
responsive to determining that the request has not been satisfied, provide a notification with a reminder of the request to a client device associated with the second user in advance of the due date.

9. The system of claim 8, wherein the processing device further to:
determine that a duplicate of the first correspondence is not present in the first communication thread or a second communication thread.

10. The system of claim 8, wherein the processing device further to:
determine that a task thread corresponding to the request has already been generated by the automated task assistant; and
associate the first correspondence with the task thread.

11. The system of claim 8, wherein the processing device further to:
generate a task thread corresponding to the request; and
responsive to determining that the request not been satisfied, terminate the task thread.

12. The system of claim 8, wherein the first correspondence comprises at least one of an email message, a text message, a chat message, or a voice message.

13. The system of claim 8, wherein to determine that the first correspondence includes a request, the processing device further to:
extract a word chain from the first correspondence; and
identify a syntactic structure of the request in the word chain that matches a predefined request template.

14. The system of claim 8, wherein the processing device further to:
determine a ranking associated with the request based on one or more characteristics of the request and of the first correspondence, wherein the one or more characteristics comprises at least one of an importance of a contact from whom the correspondence was received, sentiment analysis, the due date referenced in the first correspondence, previous actions of the user, frequency of prior correspondence with the contact, response time to prior requests from the contact, a title of the contact, or a name of the contact's company, and wherein to determine the ranking, the processing device further to:
identify a contact from whom the first correspondence was received; and
calculate a weighted sum of an importance of past correspondence with the contact, a number of communication channels associated with the contact, an average response time to prior requests from the contact and a static attribute importance value of the contact.

15. A non-transitory computer-readable storage medium storing instructions which, when executed by a processing device, cause the processing device to:
receive a copy of a first correspondence sent by a first user in a first communication thread, wherein the first correspondence is addressed to a second user and the copy is sent to an automated task assistant;
determine that the first correspondence includes a request and a due date;
monitor additional correspondence in the first communication thread to determine whether the request has been satisfied by the due date; and
responsive to determining that the request has not been satisfied, provide a notification with a reminder of the request to a client device associated with the second user in advance of the due date.

16. The non-transitory computer-readable storage medium of claim 15, wherein the instructions further cause the processing device to:
determine that a duplicate of the first correspondence is not present in the first communication thread or a second communication thread.

17. The non-transitory computer-readable storage medium of claim 15, wherein the instructions further cause the processing device to:
determine that a task thread corresponding to the request has already been generated by the automated task assistant; and
associate the first correspondence with the task thread.

18. The non-transitory computer-readable storage medium of claim 15, wherein the instructions further cause the processing device to:
generate a task thread corresponding to the request; and
responsive to determining that the request not been satisfied, terminate the task thread.

19. The non-transitory computer-readable storage medium of claim 15, wherein the first correspondence comprises at least one of an email message, a text message, a chat message, or a voice message.

20. The non-transitory computer-readable storage medium of claim 15, wherein to determine that the first correspondence includes a request, the instructions further cause the processing device to:
extract a word chain from the first correspondence; and
identify a syntactic structure of the request in the word chain that matches a predefined request template.
